(19) United States
(12) Patent Application Publication
(10) Pub. No.: US 2009/0274808 A1
(43) Pub. Date: Nov. 5, 2009

(54) Encoding method and device

(76) Inventor: Patricia Ann DiCostanzo, Seabrook, TX (US)

Correspondence Address: DELPHINE M. JAMES, 2656 SOUTH LOOP WEST #170, HOUSTON, TX, 77054, US

(21) Appl. No.: 12/082,895

(22) Filed: Apr. 14, 2008

Related U.S. Application Data
(60) Provisional application No. 60/923,623, filed on Apr. 16, 2007.

(51) Int. Cl. A23P 1/00

(52) U.S. Cl. 426/383

(57) ABSTRACT

The present invention is a tool and method for imprinting encoded messages on a food product. Preferably the food can be gum or a fruit product. The tool further comprises an imprinting cube with designated encoded symbols incorporated on each plane of the cube and a container for containing a plurality of food products. The imprinting cube is adapted to be received by the container as a lid. The method comprises utilizing each designated symbol on the cube to encode a message on the food product. The method is a system of creating each number and alphabet in the English language utilizing five designated symbols incorporated on each plane of the cube.

This patent claims priority of provisional application 60/923,623.

### BACKGROUND

The present invention relates to encoding systems. More specifically, the present invention relates to a method and tool for imprinting messages onto food products. There are many standardized coding systems such as ASCII, that encodes the 26 alphabets and 10 numbers. However, many of these systems have translations have elaborate mapping and translation system. However, the present invention provides a simple and efficient method and device for translating the twenty six alphabets and ten numbers from five symbols.

### SUMMARY

One of the advantage of the present invention is it is compact and efficient encoding system that is edible.

Another advantage is the ability to create each number and symbol in the English language from 5 designated symbols.

Another advantage is that it enables children to create, pass, and eat either explicit or coded messages.

The present invention is a tool and method for imprinting encoded messages on a food product. Preferably the food can be gum or a fruit product. The tool further comprises an imprinting cube with designated encoded symbols incorporated on each plane of the cube and a container for containing a plurality of food products. The imprinting cube is adapted to be received by the container as a lid. The method comprises utilizing each designated symbol on the cube to encode a message on the food product. The method is a system of creating each number and alphabet in the English language utilizing five designated symbols incorporated on each plane of the cube.

### BRIEF DESCRIPTION OF DRAWINGS

FIG. 1 illustrates the five symbols of the encoding system of the present invention.

FIG. 2 shows a sample of an acronym dictionary that can be utilized with the present invention.

FIG. 3 shows the implementation of the symbols used to create a message.

FIG. 4 shows the acronym system implemented one type of embodiment of the imprinting device.

FIG. 5 shows the flatted food product placed in the canister of the present invention.

FIG. 6 shows an alternative embodiment for the imprinting device.

FIG. 7 shows the alternative embodiment of FIG. 6 inserted into a canister.

FIG. 8 shows an alternative embodiment for the imprinting device with a star configuration.

FIG. 9 shows an alternative embodiment for the imprinted device with a substantially rectangular configuration.

FIG. 10 shows an alternative embodiment for the imprinting device with a solid triangular configuration.

### DETAILED SPECIFICATIONS

The detailed embodiment of the present invention is disclosed herein. The disclosed embodiment is not to be interpreted as limited, but merely as a basis for teaching one skilled in the art to make and/or use the present invention.

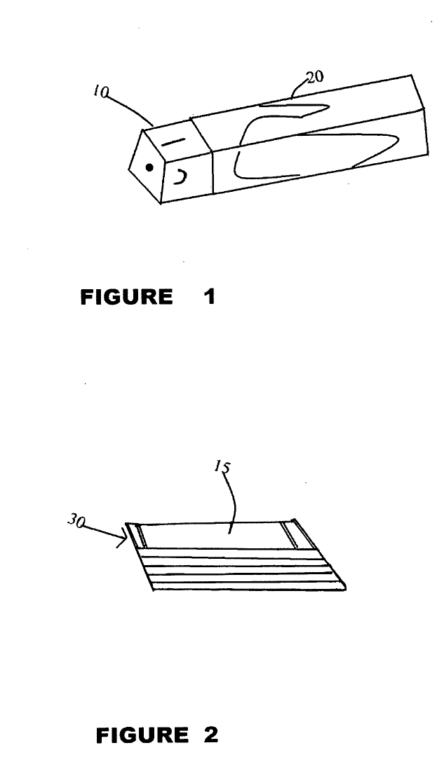

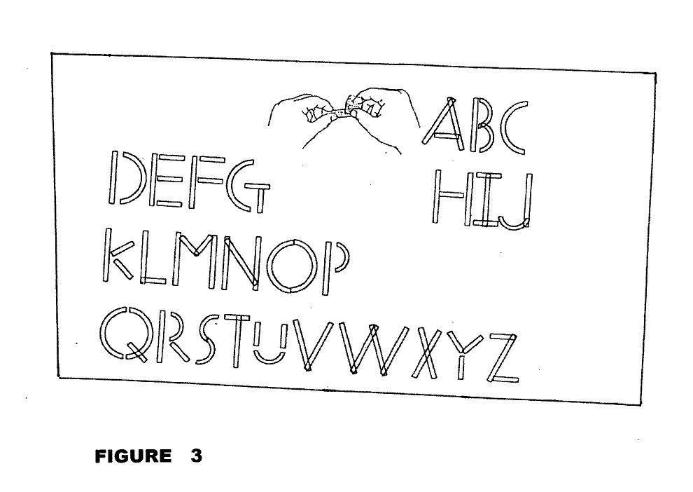

The symbols comprising the unique encoding system of the present invention are disclosed in FIG. 1. The system comprises symbol C comprising a longer line, symbol D comprising a shorter line in relation to symbol C, symbol A comprising a large semi-circle, symbol B comprising a small semi-circle in relation to symbol A and symbol E comprising a solid circle such as a period. FIG. 2 illustrates how the symbols are interconnected to create the 26 alphabets and 10 numbers. To create a full message, the user utilizes the mapping chart in FIG. 2 to create each letter or number in the alphabet. In addition, the symbols of the present invention can also be utilized to create shapes. The system also includes an acronym system of the English language. However, the symbols of the present invention can be used with any language that incorporates the same 26 alphabets and 10 numbers.

The afore mentioned encoding system can be implemented on various types of imprinting devices to creates messages by children or adults, to create decorative designs by artists, and/or to create interior designs during the construction and remodeling of buildings. Additionally, these imprinting devices can be made of acrylic, wood, foam, or another suitable hard or soft type of plastic material. The imprinting device can be created in stencils or for use with a stamping device. Instead of using the food product as described below, the message would be imprinted upon any type of flat surface, i.e. paper, sheet rock, wall paper, or concrete;

In the preferred embodiment the present invention. is preferably made from a solid plane geometric polyhedron. A calibration line can be incorporated within the plane to allow the user to form messages in a straight line. In the alternative, each symbol can be incorporated on one side of a separate flat plane geometric figure. Each encoding symbol can be recessed inwardly into the flat plane or protrude outwardly from the flat plane.

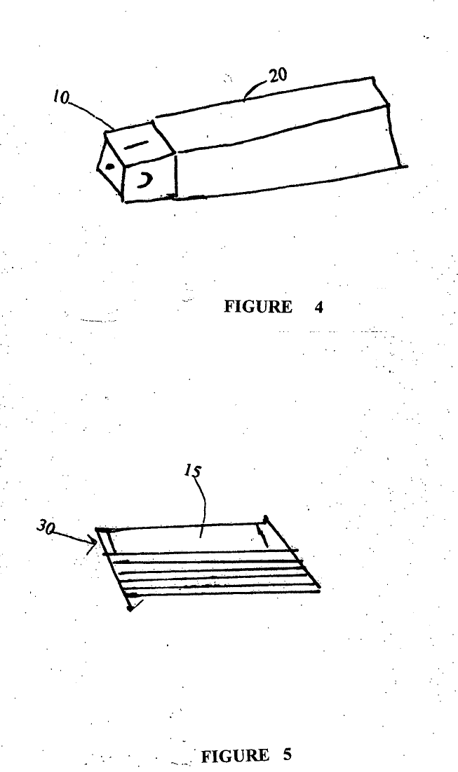

FIG. 4, illustrates one embodiment of an imprinting device incorporating the encoding system of the present invention. A six sided polyhedron geometric figure such as a cube or a star can be utilized to create an imprinting device.

The device includes an imprinting cube 10 and container 20. Imprinting cube 10 and container can be made of plastic, acrylic, or another suitable material. In the preferred embodiment, imprinting cube 10 is made of a transparent or translucent material.

Imprinting cube 10 is a solid three dimensional geometric figure bounded by 6 planes. Each of the six sides is a square containing a specific symbol. The symbol is incorporated into the external surface of each plane and protrudes slightly outward. The structure of each symbol is discussed below.

Container 20 is a hollow three dimensional geometric figure bounded by six planes. Four sides of container 20 have a rectangular configuration. However, the opposing top and bottom side has a square configuration corresponding to a side of cube 10. The top side of container 20 is opened which allows for a plurality of food products to be inserted into the container 20. As depicted the imprinting cube acts as a lid which is inserted into the opened side of container 20.

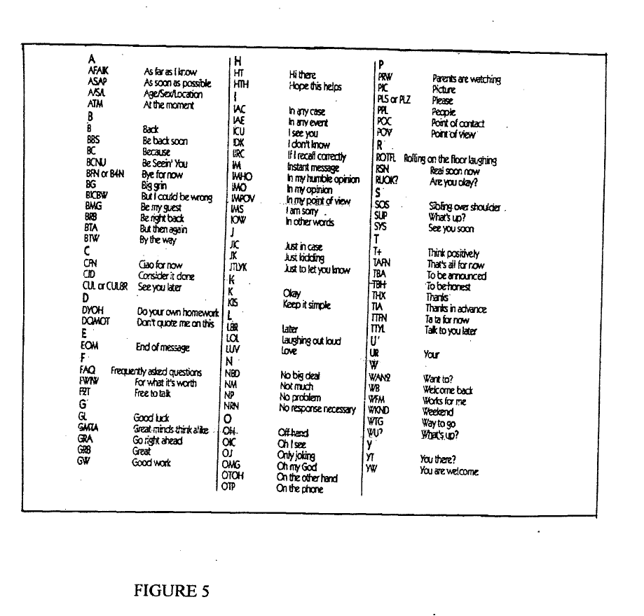

The present invention further comprises a plurality of food products 30 as shown in FIG. 5. Each food product 30 is flat and rectangular and is adapted to fit within container 20. A covering 15 surrounds each food product for receiving the encrypted message. In the preferred embodiment, the covering is made of plastic or rice paper. Rice paper is edible making the entire food product edible. In the preferred embodiment, each food product can be gum, fruit roll-up, or vegetable roll-up. However any soft flexible food product can be used.

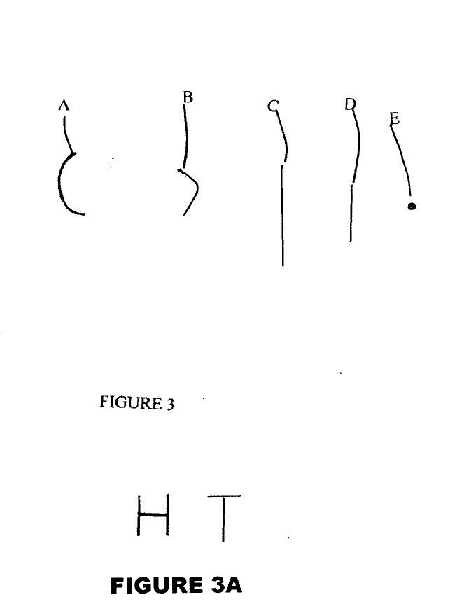

The present invention further comprises a method utilizing tool 35 of encoding a message onto food products. Each plane of imprinting cube 10 contains one of the following symbols designated as A, B, C, D, and E in FIG. 3. Symbol A is a big circle, Symbol B is a short circle, symbol C is a long line, symbol D is a short line, and symbol e is a period.

Imprinting cube 10 is used to create the each of alphabets and numbers as depicted in FIG. 3. For example to create the letter “D”, symbol C and A would be used. To create, C only symbol A would be used. The user finds the appropriate symbol on the cube and then pushes that side of the cube onto the covering of the food product. The present invention further provides the ability of users to use a special acronym. dictionary as depicted in FIG. 2. For example as shown in FIG. 3, HT can be imprinted to send a message of Hi There. To create the letter H, two vertical lines with one horizontal line extending across the middle are imprinted. To create the letter T, one long vertical line is imprinted with a shorter horizontal line perpendicularly across the top edge of the vertical line.

Additionally, the tool can be equipped with a sanitizer to prevent the spread of germs between users. Additionally, the imprinting cube 10 can be adapted with interchangeable side planes. This allows the symbols on the imprinting cube 10 to be exchanged out.

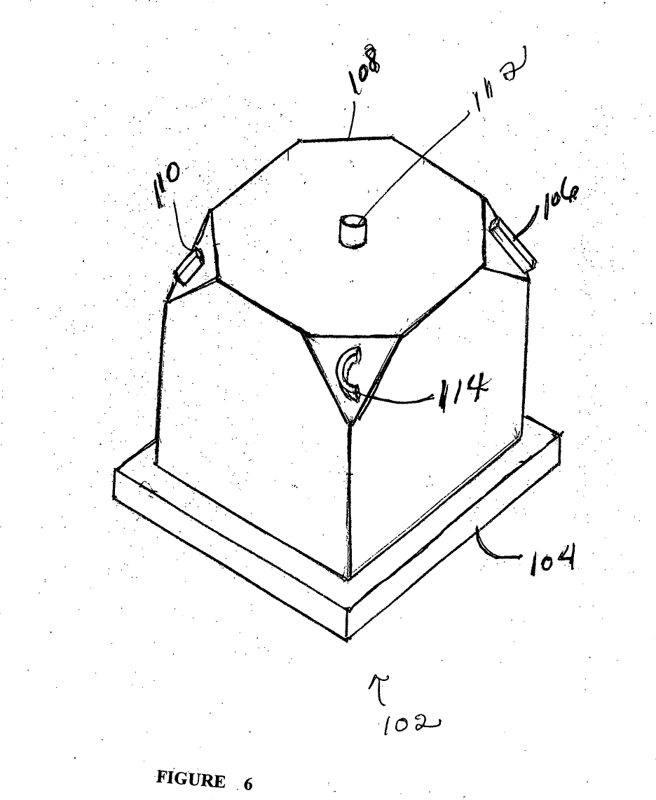

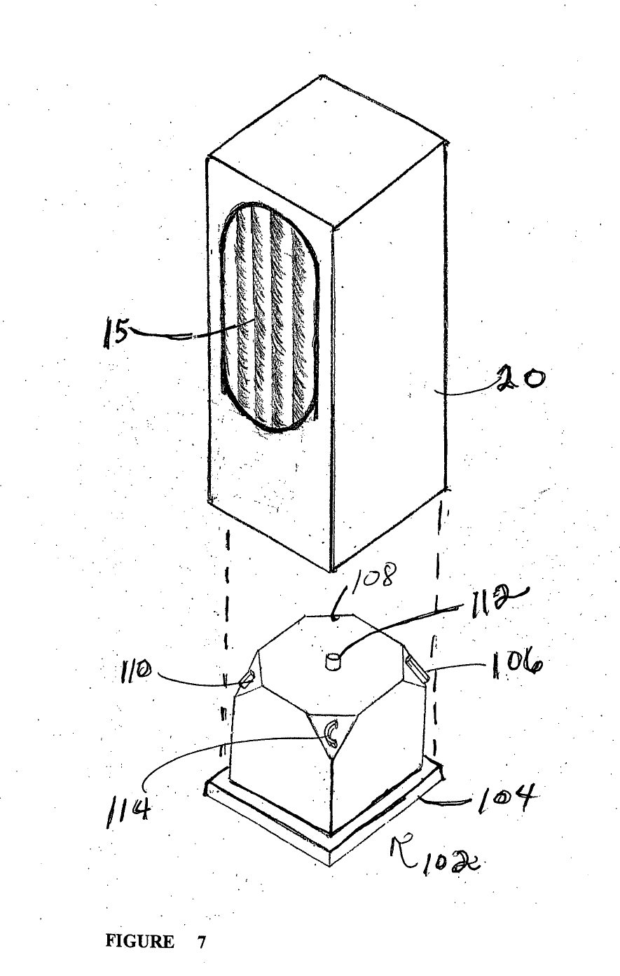

As shown in FIG. 6, the encoding symbols of the present invention can be incorporated into an alternative cube design. As depicted cube 102, is adapted with the lower flat plane fixably coupled to a support base 104. Each corner of the top plane is collapsed into a flat plane. The symbol is incorporated into each collapsed flat plane (110, 108, 106, and 114) along with the top plane 112. As shown in FIG. 7, cube 102 also is adapted to fit within canister 20 with food products 15 contained therein.

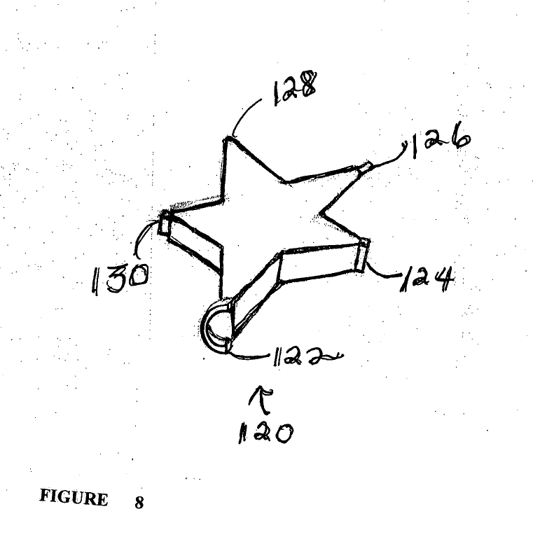

Referring to FIG. 8, there is shown an alternative embodiment, for the imprinting device, a star 120. In this configuration, each apex point of the star is collapsed into a flat plane. As depicted, each encoded symbol is incorporated into each flat plane.

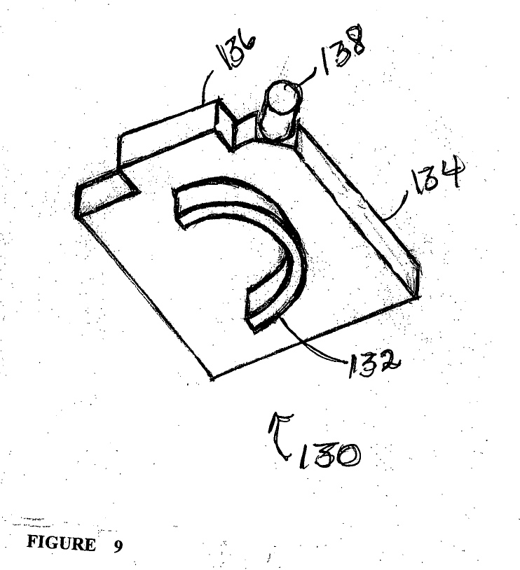

Referring to FIG. 9, there is shown an alternative embodiment for the imprinting device, a substantially rectangular polyhedron 130. In this configuration, the front and back plane incorporates the short and large semi-circle symbols. The upper edge is adapted with a shorter side to accommodate the smaller line. One side edge is adapted with the longer line. Circle 138 can be adapted protruding outward from the upper edge or can be adapted upon another side edge.

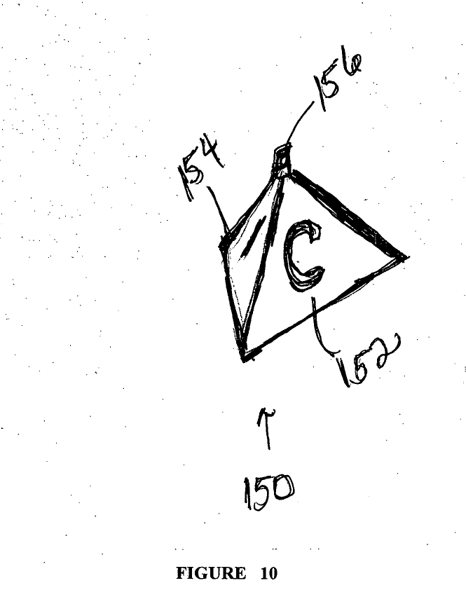

Referring to FIG. 10, there is shown an alternative embodiment for the imprinting device, a triangular solid geometric figure 150. as depicted each symbol is incorporated into a flat plane side and the solid circle 156 protrudes outward from the apex point.

What is claimed is:

1. A method of encoding the twenty six alphabet characters and 10 numeric characters, the method comprising:
(a) providing a set of encoding symbols having a longer linear line, a shorter linear line, a larger semi-circle, a smaller semi-circle, a closed circle;
(b) providing a tool with a solid three dimensional geometric figure with a plurality of flat plane sides having an encoding symbol from the set incorporated upon each flat plane of the geometric figure;
(c) providing an imprinting product adapted with a flat surface area for receiving a message;
(d) creating a predetermined message consisting of a plurality of characters;
(e) determining a predetermined sequence from the set of encoding symbols required to create the impression of each character of the predetermined message;
(f) pressing upon a side plane of the tool the flat surface area of the imprinting product wherein an encoded symbol is imprinted thereon;
(g) repeating step (f) for sequence of symbols required to create a character from the predetermined message; and
(h) repeating step (g) until each character of the predetermined message is created.
